(19) United States
(12) Patent Application Publication
(10) Pub. No.: US 2019/0368369 A1
(43) Pub. Date: Dec. 5, 2019

(54) BLADE OUTER AIR SEAL WITH COOLED NON-SYMMETRIC CURVED TEETH

(71) Applicant: Florida Turbine Technologies, Inc., Jupiter, FL (US)

(72) Inventor: George LIANG, Jupiter, FL (US)

(21) Appl. No.: 16/477,722

(22) PCT Filed: Dec. 22, 2017
(86) PCT No.: PCT/US2017/068152

§ 371 Date: Jul. 12, 2019

Related U.S. Application Data
(63) Continuation of application No. 15/405,604, filed on Jan. 13, 2017, now abandoned.

(51) Int. Cl. F01D 11/24; F01D 25/00; F01D 25/24

(52) U.S. Cl. CPC F01D 11/24; F01D 25/005; F05D 2220/32; F05D 2230/31; F05D 2300/175; F01D 25/24

(57) ABSTRACT

A blade outer air seal with a plurality of inner ring segment secured to a full annular cooled support ring, where the inner ring segments each have rows of curved teeth that form rows of curved grooves that open in a direction toward a blade tip, where the curved teeth each include curved cooling air channels that provide cooling for the BOAS. The full annular support ring is made from a low thermal expansion coefficient material and the inner ring segments are each made from an Oxide Dispersion Strengthened material using a metal additive manufacture process like directed metal laser sintering.

### CROSS-REFERENCE TO RELATED APPLICATIONS

This Application is related to and claims priority to U.S. Ser. No. 15/405,604, filed Jan. 13, 2017, entitled BLADE OUTER AIR SEAL WITH COOLED NON-SYMMETRIC CURVED TEETH, the entirety of which is incorporated herein by reference.

### GOVERNMENT LICENSE RIGHTS

None.

### TECHNICAL FIELD

The present invention relates generally to a gas turbine engine, and more specifically to a blade outer air seal having skewed non-symmetric curved teeth with cooling passages.

### BACKGROUND

In a gas turbine engine, a seal is used between a stator and a rotor of the engine. In the turbine section, this seal is formed by a blade outer air seal or BOAS, which is formed between a rotating blade tip and a stationary ring. A gap is formed between the blade tip and the ring in which hot gas passing through the turbine can leak through. The gap can change in spacing due to thermal expansion due to the hot gas flowing through the turbine.

A BOAS is typically made from an investment casing process where the cast part is finished using a metal machining process that removes metal material.

### SUMMARY

The present invention advantageously provides a blade outer air seal (BOAS) for a turbine of a gas turbine engine. The BOAS includes a low coefficient thermal expansion outer support ring with cooling air supply channels for control of blade tip clearance. The outer ring is made of INCOLOY® 909 (Huntington Alloys Corporation, Huntington, W. Va.) material. The outer ring is a fully circular active cooled isolation ring made from a low thermal expansion material to reduce radial displacement or expansion movement to reduce blade tip clearance gap during engine operation. The support ring includes three outer ring elements to provide additional stiffness to the ring channeling the cooling air. Multiple BOAS segments are attached to an inner diameter of the outer ring with multiple front hooks and an aft C-shaped clamp. The multiple segmented BOAS is made of a high temperature resistant Oxide Dispersion Strengthened (ODS) INCONEL® MA754 (Huntington Alloys Corporation, Huntington, W. Va.) material. Rows of cooled non-symmetric teeth and curved grooves follow the blade mean camber line which is formed on the outer surface of the BOAS. Also, the multiple non-symmetrical teeth are recessed relative to the turbine flow path to provide additional resistance for the turbine leakage flow.

The multiple non-symmetrical grooves are skewed in a general direction with the blade mean camber line. Cooling air is supplied from a forward end of the teeth. Spent cooling air is discharged at an aft edge and a mate-face side of the BOAS. Secondary leakage air within the grooves circulates and is discharged to reduce an effective leakage flow area and thus lower the blade leakage flow. Cooling air is supplied into the curved channels in which skewed trip strips are used to enhance heat transfer. Cooling air discharged onto the mate-face side and aft edge of the BOAS will provide additional cooling and purge air for the BOAS mate-face side.

The curved grooves in the BOAS will provide for a maximum sealing at a minimum pressure loss across the BOAS. The BOAS with the curved grooves can be formed with skewed trip strips on an inner wall and with a specific radius of curvature for each BOAS segment. An extrusion manufacturing method of the prior art cannot be used to form the curved grooves with skewed trip strips of the present invention especially with an ODS material. The BOAS with the curved grooves can be made using a directed metal laser sintering (DMLS) process.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a cross-section view from a side of the BOAS of the present invention;

FIG. 2 shows a bottom view of a section of the BOAS with curved grooves of the present invention;

FIG. 3 shows a bottom view of the BOAS with the curved grooves and spent cooling air discharge of the present invention;

FIG. 4 shows a cross-section view of the BOAS and a blade with recirculation flow and leakage flow of the present invention;

FIG. 5 shows a cross-section view of a section of the curved grooves and curved teeth of the BOAS of the present invention with cooling channels;

FIG. 6 shows a close-up view of one of the cooling channels of FIG. 5;

FIG. 7 shows a cross-section side view of one of the curved cooling channels of the BOAS of the present invention from FIG. 5; and

FIG. 8 shows a cross-section view of a section of the grooves and teeth of the BOAS of the present invention with dimensions and angle.

### DETAILED DESCRIPTION

The present invention is a blade outer air seal (BOAS) for a gas turbine engine with a full circular support ring made from a low thermal expansion material and with three outer ring elements to provide additional stiffness to the support ring, a plurality of blade outer air seal (BOAS) segments that are attached to an inner side of the support ring, and in which the BOAS has a series of curved teeth that form a series of curved grooves, and where the curved teeth have cooling air channels formed therein such that the curved teeth can be cooled. The BOAS with curved teeth and cooling channels can be formed using a metal additive manufacturing process such as direct metal laser sintering (DMLS) from a high temperature resistant material such as nickel super alloys or even an oxide dispersion strengthened (ODS) material.

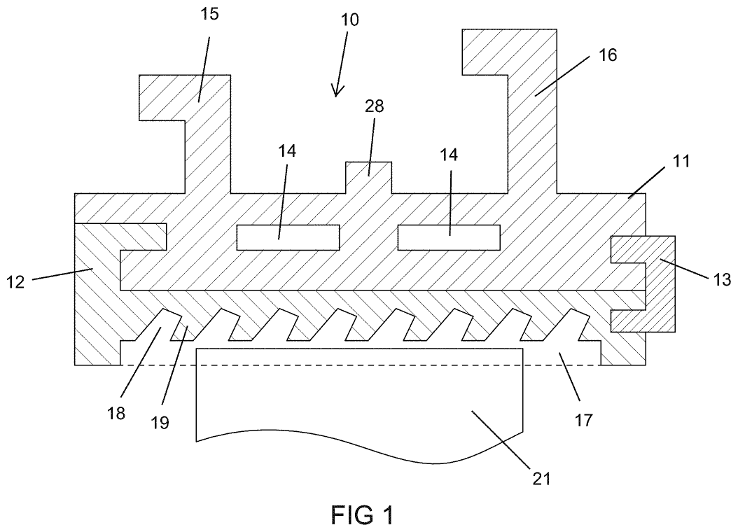

FIG. 1 shows a BOAS 10 of the present invention with an outer support ring 11, two cooling air supply channels 14, and a plurality of inner ring segments 12 each with an inner surface and an outer surface. The inner surface has a number of curved teeth 19 that form curved grooves 18, and a C-shaped clamp 13 that secures the inner ring segment 12 to the outer support ring 11 to form the BOAS 10. The outer support ring 11 is a fully annular ring made of a low expansion coefficient material such as INCOLOY® 909. The outer support ring 11 has three ring elements 15, 16, and 28 that extend out from the top side and are full annular rings that provide additional stiffness to the outer support ring 11 and to secure the outer support ring 11 within a casing of the gas turbine engine. The first ring element 15 is a forward hook 15 and the third ring element is an aft hook 16. The second ring element 28 is between the first 15 and second 16 ring elements. The three ring elements 15, 16, and 28 extend outward from the body of the outer support ring 11 and are further away from the hot gas flow path. Thus, the three ring elements 15, 16, and 28 operate at cooler metal temperatures than the body of the support ring 11 below. The cooling air supply channels 14 and the three ring elements 15, 16, and 28 keep the radial displacement of the outer support ring 11 to a minimum so that the blade tip clearance gap is also at a minimum.

The multiple pieces of the inner ring segment 12 are made from a high temperature resistant ODS material such as MA754. The inner ring segment 12 includes recessed circumferential groove 17, within which a tip of a rotor blade 21 rotates. The curved grooves 18 open into this circumferential groove 17. The high temperature resistant material inner ring segment 12 is made using a metal additive manufacture process such as a DMLS process due to its complexity to be described below. Additionally or alternatively, the inner ring segment 12 can also be made from a nickel based super alloy.

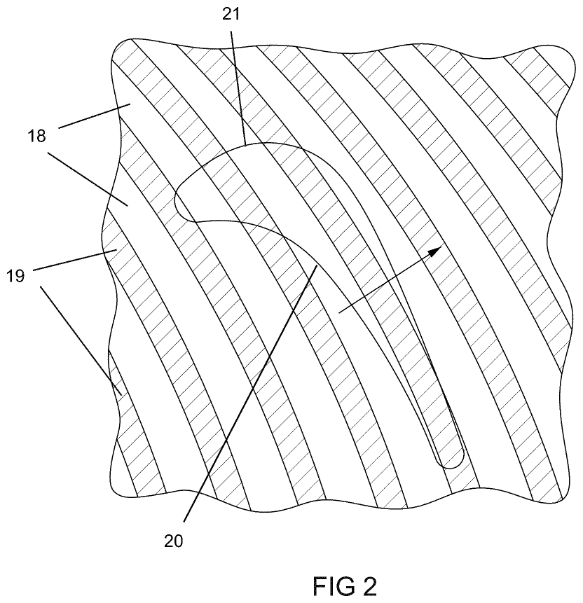

FIG. 2 shows one of the features of the BOAS 10 of the present invention, in that the curved grooves 18 are curved skewed forward and arranged substantially in line with the airfoil aft section mean camber line of the blade 21. The arrow in FIG. 2 represents a direction of leakage flow through a gap formed between the rotor blade 21 tip and the BOAS 10. The curved teeth 19 form the curved grooves 18. The rotor blade 21 has a pressure side wall 20 in which a trailing edge section has a wall surface substantially parallel to the curved grooves 18 and curved teeth 19 at this section as seen in FIG. 2. As seen in FIG. 2, the curved teeth 19 and curved grooves 18 are curved in a direction of the pressure side wall 20 surface of the rotor blade 21.

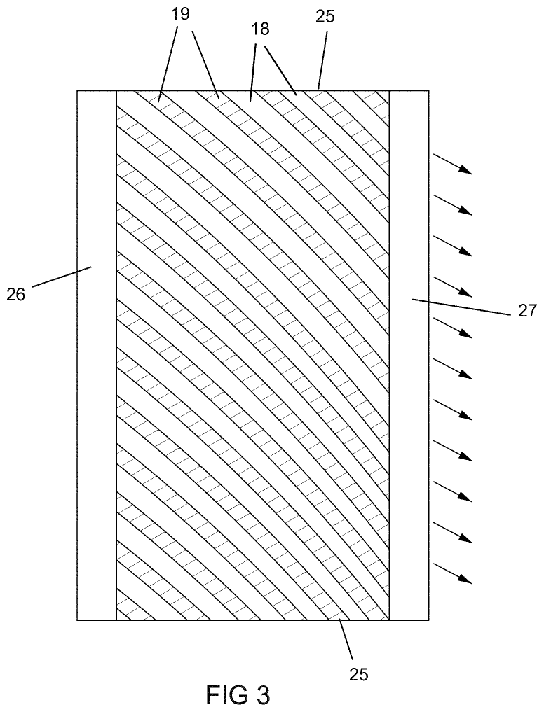

FIG. 3 shows a bottom view of the BOAS 10 with the curved teeth 19 and curved grooves 18. Cooling air passing through the curved cooling air channels 22 (for example, as shown in FIGS. 5-7) within the teeth 19 flows out on an aft edge 27 of the BOAS 10 as well as a mate-face side 25 of the BOAS 10 on the bottom side shown in FIG. 3. The BOAS 10 includes two mate-face sides 25, a forward edge 26, and an aft edge 27.

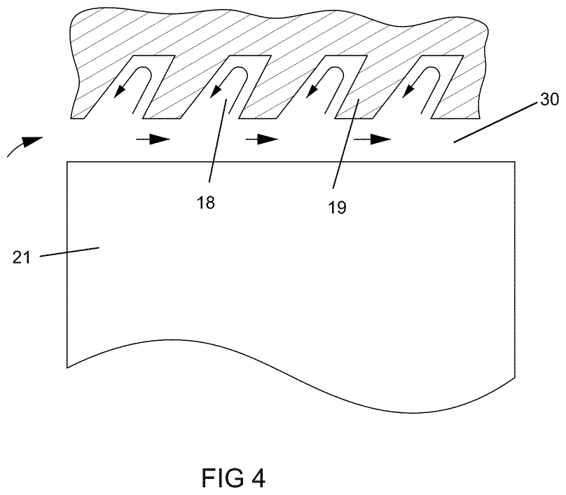

FIG. 4 shows a cross-sectional view of the BOAS 10 and a rotor blade 21 with a tip. The skewed curved grooves 18 produce a recirculation flow of secondary leakage air as represented by the arrows in FIG. 4. A leakage flow is represented by the straight arrows located in a gap 30 between the rotor blade 21 tip and the curved teeth 19. The secondary leakage air will pinch the leakage flow and thus reduce the effective leakage flow area, which then reduces the overall leakage flow across the rotor blade tip.

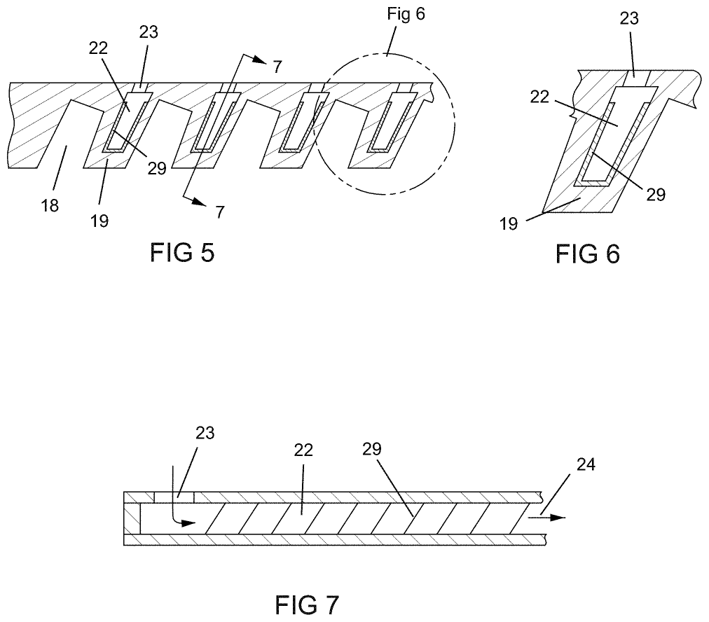

FIG. 5 shows a cross-section view of the BOAS 10 with the curved grooves 18 formed by the curved teeth 19. Each of the curved teeth 19 also include a curved cooling air channel 22 that extends along a length of the curved tooth 19 and is supplied with cooling air through cooling air feed holes 23 (or inlet openings 23) opening above the BOAS 10 on an upstream end (forward end) of the curved cooling air channel 22. FIG. 6 shows a close-up view of one of the curved teeth 19 with a curved cooling air channels 22 of FIG. 5 that extends along a length of the tooth 19. The skewed trip strips 29 are formed on both side walls and the bottom wall of each of the curved cooling air channels 22. FIG. 7 shows a cross-section side view of one of these curved cooling air channels 22 with the cooling air feed hole 23 and a discharge opening 24 in the aft end of the curved tooth 19. The forward end and the aft end of each of the plurality of curved teeth 19 are circumferentially offset. The cooling air feed hole 23 is on an upstream side and the discharge opening 24 is on a downstream side of the of the curved cooling air channel 22. U-shaped skewed trip strips 29 are formed along the walls of each of the curved cooling air channels 22 to enhance heat transfer from the hot surfaces to the cooling air flow.

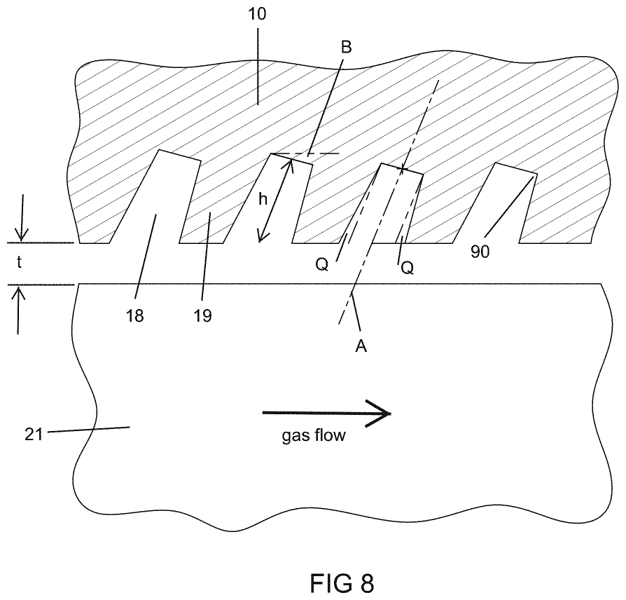

FIG. 8 shows a cross-section view of the curved groves 18 in which the curved grooves have a depth (h) and a blade tip clearance (t) between the curved teeth 19 and the tip of the rotor blade 21. The curved grooves 18 have side walls that are not parallel, but instead diverge from an axis of the curved groove (A) at an angle (Q) such that the open end of the curved groove 18 is wider than the closed end opposite the open end. In one embodiment of the present invention, the curved groove depth (h) is 2 to 5 times the rotor blade tip clearance (t); the curved groove slant angle (A) is at an angle of 60 to 70 degrees relative to engine centerline; the front face and aft face of each curved groove 18 is at 5 to 7 degrees divergent (Q) from the curved groove centerline (which coincides with line A in FIG. 8); and the curved groove bottom face is 90 degrees (labeled as 90 in FIG. 8) relative to the aft face. A chamber angle (B) (an angle between the axis of the rotor and the bottom side of the groove) is at 90 degrees minus groove angle (Q) and aft face divergent angle at approximately 15 degrees. A gas flow direction is indicated by an arrow in FIG. 8. Thus, the front face of each of the curved grooves 18 would be in the left side and the aft face if each of the curved grooves 18 would be on the right side with respect to the gas flow direction.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A blade outer air seal for a gas turbine engine, the blade outer air seal comprising:
an inner ring segment having an outer surface and an inner surface;
the inner surface having a plurality of curved teeth forming a plurality of curved grooves that open into a gap formed between the blade outer air seal and a tip of a rotor blade;
each of the plurality of curved teeth having a curved cooling air channel extending substantially along a length of the curved tooth; and
each curved cooling air channel having a cooling air feed hole on an upstream side and a discharge opening on a downstream side to pass cooling air through each of the curved cooling air channels.

2. The blade outer air seal of claim 1, wherein:
each of the curved grooves has divergent walls such that an open end is wider than a closed end.

3. The blade outer air seal of claim 1, wherein: each discharge opening is on an aft edge and a mate-face side of the blade outer air seal.

4. The blade outer air seal of claim 1, wherein:
the plurality of curved teeth and the plurality of curved grooves and a pressure side wall in a trailing edge section of a rotor blade are substantially parallel.

5. The blade outer air seal of claim 1, wherein:
the inner ring segment is formed from an oxide dispersion strengthened material.

6. The blade outer air seal of claim 1, wherein:
the inner ring segment is secured to an outer support ring with a forward hook and a C-shaped clamp.

7. The blade outer air seal of claim 1, wherein:
the plurality of curved teeth and the plurality of curved grooves are curved in a direction of a pressure side surface of a rotor blade.

8. The blade outer air seal of claim 1, wherein:
the inner ring segment is made from an oxide dispersion strengthened material using a metal additive manufacture process.

9. A turbine of a gas turbine engine comprising:
an annular support ring with a forward hook and an aft hook to secure the annular support ring within a casing of the gas turbine engine;
a plurality of ring segments secured to an under side of the annular support ring to form a blade outer air seal;
the plurality of ring segments each having an underside with a plurality of curved teeth forming a plurality of curved grooves;
each of the plurality of curved teeth having a cooling air channel formed therein with an inlet opening for cooling air and a discharge opening to discharge cooling air; and
a turbine rotor blade rotating within a recessed circumferential groove formed on an underside of each of the plurality of ring segments.

10. A turbine of a gas turbine engine comprising:
an annular support ring with a forward hook and an aft hook to secure the annular support ring within a casing of the gas turbine engine;
a plurality of ring segments secured to an under side of the annular support ring to form a blade outer air seal;
the plurality of ring segments each having an underside with a plurality of curved teeth forming a plurality of curved grooves;
each of the plurality of curved teeth have a cooling air channel formed therein with an inlet opening for cooling air and a discharge opening to discharge cooling air; and
the plurality of curved teeth and the plurality of curved grooves of the plurality of ring segments are substantially parallel to a pressure side wall in a trailing edge section of a rotating turbine rotor blade.

11. A turbine of a gas turbine engine comprising:
an annular support ring with a forward hook and an aft hook to secure the annular support ring within a casing of the gas turbine engine;
a plurality of inner ring segments secured to an under side of the annular support ring to form a blade outer air seal;
the plurality of inner ring segments each having an underside with a plurality of curved teeth forming a plurality of curved grooves;
each of the plurality of teeth having a cooling air channel formed therein with an inlet opening for cooling air and a discharge opening to discharge cooling air; and
each of the plurality of inner ring segments being made from an oxide dispersion strengthened material.

12. A blade outer air seal for a gas turbine engine, the blade outer air seal comprising:
an inner ring segment having an outer surface and an inner surface;
the inner surface having a plurality of curved teeth forming a plurality of curved grooves; and
each of the plurality of curved teeth forming a curved cooling air channel from a forward end to an aft end of the curved tooth wherein the forward end and the aft end of the tooth are circumferentially offset.

13. The blade outer air seal of claim 12, wherein:
some of the plurality of the curved cooling air channels 22 have an forward end on a forward edge of the blade outer air seal and an aft end along a mate face side and along the aft edge of the blade outer air seal.

14. The blade outer air seal of claim 12, wherein:
each of the curved cooling air channels includes a cooling air feed hole on the forward end and a discharge opening on the aft end to pass cooling air through each of the curved cooling air channels.

15. The blade outer air seal of claim 12, and further comprising:
a recessed circumferential groove formed on the inner surface in which a turbine rotor blade can rotate.

16. The blade outer air seal of claim 12, wherein:
the plurality of curved grooves are substantially parallel to a pressure side wall in a trailing edge section of a rotating turbine rotor blade.

17. A blade outer air seal for a gas turbine engine, the blade outer air seal comprising:
an inner ring segment having an outer surface exposed to a hot gas flow and an inner surface opposite to the outer surface;
the inner ring segment having a forward edge, an aft, and two mate face sides;
the inner surface having a plurality of curved teeth forming a plurality of curved grooves; and
each of the plurality of curved teeth forming a curved cooling air channel from one end to an opposite end of the curved cooling air channel.

18. The blade outer air seal of claim 17, wherein:
inlet ends of the plurality of curved cooling air channels are located on both the forward edge and one of the two mate face sides; and
outlet ends of the plurality of curved cooling air channels are located on both the aft edge and the other of the two mate face sides.
